(19) United States
(12) Patent Application Publication
(10) Pub. No.: US 2025/0104113 A1
(43) Pub. Date: Mar. 27, 2025

(54) DISPLAY CONTROL SYSTEM IN ACCORDANCE WITH POSITION INFORMATION, DISPLAY CONTROL METHOD IN ACCORDANCE WITH POSITION INFORMATION, AND INFORMATION STORAGE MEDIUM

(71) Applicant: Rakuten Group, Inc., Tokyo (JP)

(72) Inventor: Daigo HAYASAKA, Tokyo (JP)

(73) Assignee: Rakuten Group, Inc., Tokyo (JP)

(21) Appl. No.: 18/443,524

(22) Filed: Feb. 16, 2024

(30) Foreign Application Priority Data
Sep. 27, 2023 (JP) 2023-166237

(51) Int. Cl. G06Q 30/0251

(52) U.S. Cl. CPC G06Q 30/0259

(57) ABSTRACT

Provided is a display control system in accordance with position information, the display control system including at least one processor configured to: acquire position information on a position of a first store at which payment based on a user terminal of a user has been executed; acquire advertisement information on an advertisement for one of a second article or a second service dealt in at a second store based on the position information; and display on the user terminal a payment completion screen that relates to completion of the payment and includes the advertisement indicated by the advertisement information.

### CROSS-REFERENCE TO RELATED APPLICATION

The present application claims priority from Japanese application JP 2023-166237 filed on Sep. 27, 2023, the content of which is hereby incorporated by reference into the application.

### BACKGROUND OF THE INVENTION

### 1. Field of the Invention

The present disclosure relates to a display control system in accordance with position information, a display control method in accordance with position information, and an information storage medium.

### 2. Description of the Related Art

Hitherto, there has been known a technology of displaying on a user terminal a screen in accordance with position information acquired based on signals from satellites received by a GPS receiver or the like. As an acquisition method for the position information, various methods other than the method that uses the GPS receiver are known. For example, in JP 2023-088782 A, there is described a system for identifying a coupon which a user can use at a second store within a predetermined distance from a first store at which payment based on a user terminal of the user has been executed. The system as described in JP 2023-088782 A displays on the user terminal a payment completion screen indicating completion of the payment at the first store and a coupon useable for all articles at the second store.

### SUMMARY OF THE INVENTION

However, the coupon displayed on the payment completion screen in JP 2023-088782 A is not a coupon for a specific article or service dealt in at the second store, and hence the user cannot recognize articles or services dealt in at the second store. Thus, with the technology of JP 2023-088782 A, even when the user views the coupon on the payment completion screen, the user may not get interested in the second store.

One object of the present disclosure is to effectively urge a user who has used a first store to use a second store.

According to at least one embodiment of the present disclosure, there is provided a display control system in accordance with position information, the display control system including at least one processor configured to: acquire position information on a position of a first store at which payment based on a user terminal of a user has been executed; acquire advertisement information on an advertisement for one of a second article or a second service dealt in at a second store based on the position information; and display on the user terminal a payment completion screen that relates to completion of the payment and includes the advertisement indicated by the advertisement information.

### BRIEF DESCRIPTION OF THE DRAWINGS

FIG. 1 is a diagram for illustrating an example of a hardware configuration of a display control system.

FIG. 2 is a view for illustrating an example of screens displayed on a user terminal.

FIG. 3 is a diagram for illustrating an example of a relationship among a first store, second stores, and third stores.

FIG. 4 is a diagram for illustrating an example of functions implemented in the display control system.

FIG. 5 is a table for showing an example of a user database.

FIG. 6 is a table for showing an example of a store database.

FIG. 7 is a diagram for illustrating an example of processing executed in the display control system.

FIG. 8 is a diagram for illustrating an example of functions implemented in modification examples of the present disclosure.

### DETAILED DESCRIPTION OF THE INVENTION

### 1. Hardware Configuration of Display Control System

An example of at least one embodiment of a display control system in accordance with position information, a display control method in accordance with position information, and a program according to the present disclosure is described.

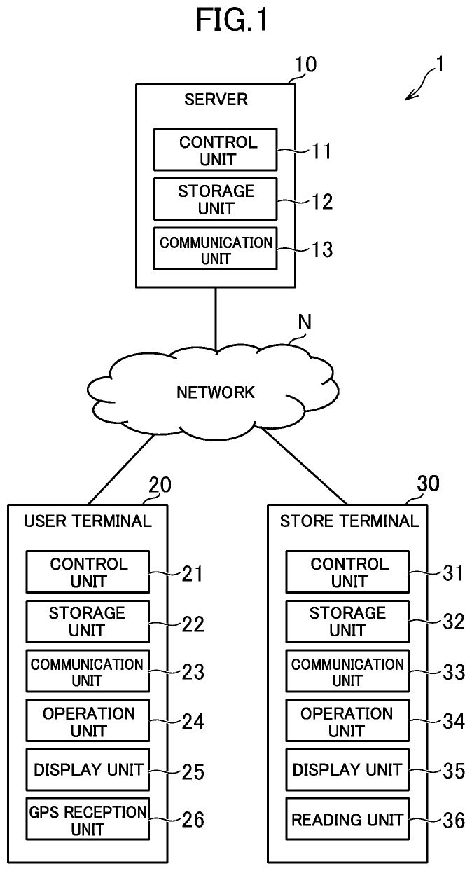

FIG. 1 is a diagram for illustrating an example of a hardware configuration of the display control system. For example, a display control system 1 includes a server 10, a user terminal 20, and a store terminal 30. Each of the server 10, the user terminal 20, and the store terminal 30 is connected to a network N, such as the Internet or a LAN. In the example of FIG. 1, one server 10, one user terminal 20, and one store terminal 30 are illustrated, but for at least one of the server 10, the user terminal 20, or the store terminal 30, a plurality thereof may exist.

The server 10 is a server computer of an operator operating a payment service. The payment service is a service relating to electronic payment (cashless payment). For example, the server 10 includes a control unit 11, a storage unit 12, and a communication unit 13. The control unit 11 includes at least one processor. The storage unit 12 includes at least one of a volatile memory such as a RAM or a nonvolatile memory such as a flash memory. The communication unit 13 includes at least one of a communication interface for wired communication or a communication interface for wireless communication.

The user terminal 20 is a computer of a user who uses the payment service. For example, the user terminal 20 is a smartphone, a tablet computer, a personal computer, or a wearable terminal. For example, the user terminal 20 includes a control unit 21, a storage unit 22, a communication unit 23, an operation unit 24, a display unit 25, and a GPS reception unit 26. Hardware configurations of the control unit 21, the storage unit 22, and the communication unit 23 may be the same as those of the control unit 11, the storage unit 12, and the communication unit 13, respectively. For example, the operation unit 24 is an input device, such as a touch panel or a mouse. The display unit 25 is a display, such as a liquid crystal display or an organic EL display. The GPS reception unit 26 is a receiver which receives signals from satellites.

The store terminal 30 is a computer of a member store which is a member of the payment service. For example, the store terminal 30 is a POS terminal, a self-checkout cash register, a personal computer, a tablet computer, or a smartphone. The store terminal 30 includes a control unit 31, a storage unit 32, a communication unit 33, an operation unit 34, a display unit 35, and a reading unit 36. Hardware configurations of the control unit 21, the storage unit 22, the communication unit 23, the operation unit 24, and the display unit 25 may be the same as those of the control unit 11, the storage unit 12, the communication unit 13, the operation unit 24, and the display unit 25, respectively. The reading unit 36 is a device (for example, a camera, a code reader, or a reader/writer) which can read a code or an IC chip.

Programs stored in the storage units 12, 22, and 32 may be supplied to the server 10, the user terminal 20, or the store terminal 30, respectively, via the network N. Moreover, at least one of a reading unit (for example, a memory card slot) for reading a computer-readable information storage medium or an input/output unit (for example, a USB port) for inputting/outputting data from/to an external device may be included in the server 10, the user terminal 20, or the store terminal 30. For example, a program stored in an information storage medium may be supplied to the server 10, the user terminal 20, or the store terminal 30 via at least one of the reading unit or the input/output unit.

Moreover, the display control system 1 is only required to include at least one computer. The computers included in the display control system 1 is not limited to the example of FIG. 1. For example, the display control system 1 may include only the server 10. In this case, the user terminal 20 and the store terminal 30 exist outside the display control system 1. The display control system 1 may include only the server 10 and the store terminal 30. In this case, the user terminal 20 exists outside the display control system 1. The display control system 1 may include only the server 10 and the user terminal 20. In this case, the store terminal 30 exists outside the display control system 1. The display control system 1 may include only another computer not shown in FIG. 1.

### 2. Overview of Display Control System

In the at least one embodiment, the user uses the payment service based on the user terminal 20. For example, in the at least one embodiment, a case in which the user presents a code (for example, a barcode or a 2D code) displayed on the user terminal 20 to use the payment service is exemplified. A payment method itself in the payment service may be publicly-known various methods. For example, the payment method may be a method that uses the communication unit 23, a method that uses an IC chip of the user terminal 20, or another method.

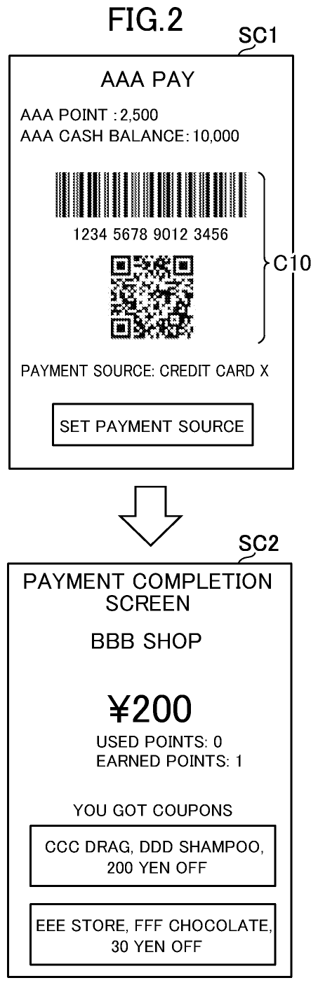

FIG. 2 is a diagram for illustrating an example of screens displayed on the user terminal 20. For example, when the user starts a payment application installed on the user terminal 20, the user terminal 20 displays a top screen SC1 of the payment application on the display unit 25 as illustrated on the upper side of FIG. 2. The payment application is an application provided by the operator of the payment service. On the top screen SC1, a code C10 obtained by encoding information required for the payment is displayed. For example, user identification information which can be used to identify the user is encoded into the code C10.

For example, when the store terminal 30 reads the code C10 through the reading unit 36, the store terminal 30 communicates to and from the server 10, to thereby execute the payment. Processing for the payment may be publicly-known processing. For example, in the store terminal 30, not the type of payment of reading the code C10 through the store terminal 30, but a type of payment of reading a code displayed on the store terminal 30 or a code displayed in the store through use of the user terminal 20 may be executed. Moreover, for example, a type of payment which is completed by only operating the user terminal 20 may be executed. A type of payment of holding an IC chip of the user terminal 20 over the reading unit 36 may be executed.

In the at least one embodiment, advertisements for articles and services dealt in at other stores in a neighborhood of the store at which the user has executed the payment are displayed on the user terminal 20. The store at which the user has executed payment is hereinafter referred to as “first store.” The other stores in the neighborhood of the first store are referred to as “second stores.” For example, the second store is a store of an advertiser. The advertiser may be a person of a store other than the second store. Other stores which are not in the neighborhood of the first store are referred to as “third stores.” Each of the first store, the second store, and the third store includes their own store terminal 30. When the first store, the second store, and the third store are not required to be distinguished from one another, the first store, the second store, and the third store are hereinafter simply referred to as “stores.”

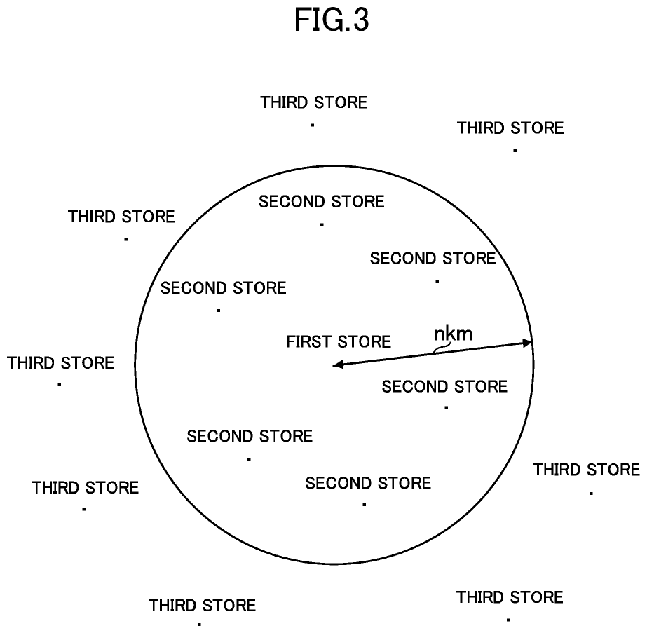

FIG. 3 is a diagram for illustrating an example of a relationship among the first store, the second stores, and the third stores. For example, of all member stores of the payment service, another store at a distance less than “n” (“n”: positive number) km from the first store corresponds to the second store. Of all member stores of the payment service, another store at a distance of “n” km or more from the first store corresponds to the third store. As illustrated in FIG. 3, the number of the second stores is not limited to one. A plurality of second stores may exist. A second store may not exist depending on the location of the first store.

For example, when the server 10 receives a payment request from the first store, the server 10 identifies a second store at a distance less than “n” km from the first store. When a plurality of second stores exist, the server 10 narrows down, based on any method, the second stores to stores the advertisements for which are to be displayed. In the at least one embodiment, a case in which the server 10 randomly narrows down the second stores is described. Other methods of narrowing down are described in modification examples described later. As illustrated on the lower side of FIG. 2, the server 10 displays on the user terminal 20 a payment completion screen SC2 indicating completion of the payment and advertisements for articles and services dealt in at the second stores.

As described above, the display control system 1 displays on the user terminal 20 the payment completion screen SC2 indicating the advertisements for the articles and the services dealt in at the second stores in the neighborhood of the first store at which the user has executed the payment. The article dealt in at the second store is hereinafter referred to as “second article.” The service dealt in at the second store is hereinafter referred to as “second service.” The display control system 1 displays the advertisements for specific second articles or second services dealt in at the second stores on the payment completion screen SC2 on which the user focuses after the payment, and hence it is possible to effectively urge the user who has used the first store to use the second store. Details of the at least one embodiment are now described.

### 3. Functions Implemented in Display Control System

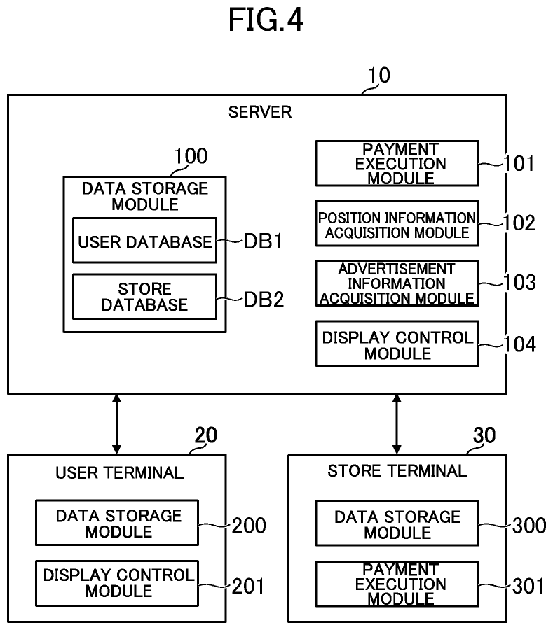

FIG. 4 is a diagram for illustrating an example of functions implemented in the display control system 1.

### [3-1. Functions Implemented in Server]

For example, the server 10 includes a data storage module 100, a payment execution module 101, a position information acquisition module 102, an advertisement information acquisition module 103, and a display control module 104. The data storage module 100 is implemented by the storage unit 12. Each of the payment execution module 101, the position information acquisition module 102, the advertisement information acquisition module 103, and the display control module 104 is implemented by the control unit 11.

### [Data Storage Module]

The data storage module 100 stores data required to provide the payment service to the user. For example, the data storage module 100 stores a user database DB1 and a store database DB2.

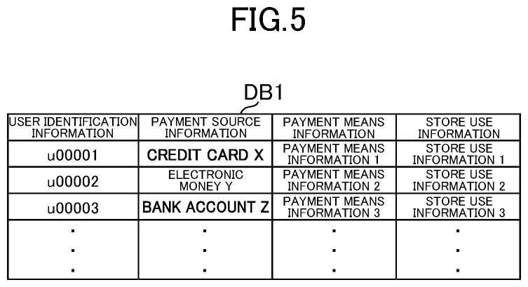

FIG. 5 is a table for showing an example of the user database DB1. The user database DB1 is a database which stores various types of information on each of a plurality of users. For example, the user database DB1 stores user identification information, payment source information, payment means information, and store use information. In the user database DB1, any information may be stored. The information stored in the user database DB1 is not limited to the example of FIG. 5. For example, in the user database DB1, balance information on a balance of payment means may be stored.

The user identification information is information which can be used to identify the user. For example, the user identification information is characters, numbers, other symbols, or a combination thereof. The user identification information may be information for the user to log in to the payment service or temporary information issued by the server 10. In the at least one embodiment, a case in which the user identification information is temporary information to be encoded into the code C10 is exemplified. In this case, another piece of user identification information for the user to log in to the payment service may be stored in the user database DB1. For example, the another piece of user identification information may a user ID, an electronic mail address, a telephone number, or other information.

The payment source information is information on payment means set by the user as a payment source of the payment service. In the payment service, the user can use any payment means. For example, the payment means which the user can use may be a credit card, electronic money, a bank account, an account of a financial institution other than the bank, an account of an institution other than the financial institution, a debit card, a reward point card, a cryptographic asset, a digital wallet, or another payment means. For example, the user can set any payment means of the plurality of payment means as the payment source. The payment means information is information on the payment means registered by the user in the payment service. In the payment service, the user can register any payment means. For example, the user can set the payment means indicated by the payment means information as the payment source.

The store use information is information on a use situation of the user in the payment service. The use situation can also be considered as a use history. For example, the store use information indicates a date and time of use of the payment service, store identification information on the store used by the user, an amount of use, information on the payment means used in the payment, or a combination thereof. The store use information may indicate at least one of article identification information on articles purchased at the used store or service identification information on services used at the used store. When the user uses the payment service at a store, the server 10 updates the store use information so that the store use information indicates that the user has used this store.

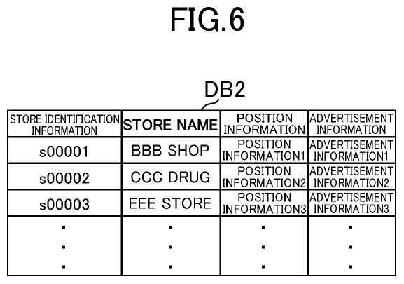

FIG. 6 is a table for showing an example of the store database DB2. The store database DB2 is a database which stores various types of information on each of the plurality of stores which are the members of the payment service. For example, in the store database DB2, store identification information, store names, position information, and advertisement information are stored. In the store database DB2, any information may be stored. The information stored in the store database DB2 is not limited to the example of FIG. 6. For example, in the store database DB2, store identification information on neighborhood stores of each store, histories of the payment executed at the stores, or information on the articles and the services dealt in at the stores may be stored.

The store identification information is information which can be used to identify the store. For example, the store identification information is characters, numbers, other symbols, or a combination thereof. The store identification information may be information for the store to log in to the payment service. For example, the store identification information may be a store ID being an ID assigned to the store, an electronic mail address of the store, a telephone number of the store, or other information. The store name or the position information may correspond to the store identification information.

The position information is information on the position of the store. In the at least one embodiment, a case in which the latitude and the longitude of the store correspond to the position information is exemplified. The position information is only required to be information which can be used to identify a position on the earth. The position information may be any information. For example, the position information may be coordinates other than the longitude and the latitude, an address of the store, identification information on a communication device arranged in the store or the neighborhood thereof, base station information on a cell phone, or other information.

The advertisement information is information on the advertisements for the store. In the at least one embodiment, the advertisement information on advertisements for the articles and the services dealt in at the store is exemplified. For example, the advertisement information indicates article identification information which can be used to identify an article being a target of the advertisement, service identification information which can be used to identify a service being the target of the advertisement, specific content of the advertisement to be displayed on the payment completion screen SC2, or a combination thereof. In the at least one embodiment, a case in which the advertisement information indicates not an advertisement for an entire store, but an advertisement for specific articles or services dealt in at the store (a part of entire articles and entire services dealt in at the store) is exemplified, but the advertisement information may be information on an advertisement for the store itself.

For example, the advertisement information may indicate an advertisement for one article or one service, or an advertisement for each of a plurality of articles or a plurality of services. In the at least one embodiment, a case in which a coupon for the article or the service corresponds to the advertisement is exemplified. The advertisement may be of any type. For example, the advertisement may be a free exchange coupon for an article, a free exchange coupon for a service, a reservation ticket for an article or a service, a link to a webpage for an article or a service, or of another type.

The data stored in the data storage module 100 is not limited to the above-mentioned example. The data storage module 100 is only required to store data required for the payment service. For example, the data storage module 100 may store data on various screens such as the payment completion screen SC2.

### [Payment Execution Module]

The payment execution module 101 executes the payment. As described above, the processing for the payment may be publicly-known processing. For example, the payment execution module 101 receives payment based on a payment request received from the user terminal 20 or the store terminal 30. The payment request is data which is in a predetermined form, and indicates the request for the payment. The payment request includes information required for the payment. For example, the payment request includes the user identification information extracted from the code C10 and the store identification information and the amount of use stored in the store terminal 30. The server 10 can identify the payment means of the user to be used for the payment based on the user identification information included in the payment request. The server 10 can identify the store from which the payment request has been received based on the store identification information included in the payment request. The payment request may include other information.

For example, the payment execution module 101 identifies the payment source information associated with the user identification information included in the payment request based on the user database DB1. The payment execution module 101 executes the payment corresponding to the amount of use included in the payment request based on the identified payment source information. For example, when the payment source information indicates a credit card, the payment execution module 101 executes credit card payment. When the payment source information indicates other payment means, the payment execution module 101 is only required to execute payment based on the other payment means. The payment execution module 101 transmits a payment completion notification to the store terminal 30 indicated by the store identification information included in the payment request. The payment completion notification is data which is in a predetermined form, and indicates that the payment has been completed.

The payment may be executed outside the display control system 1. In this case, the display control system 1 is not required to include the payment execution module 101. Further, the data stored in the data storage module 100 may be managed outside the display control system 1, and hence the display control system 1 according to the at least one embodiment may not include the data storage module 100 and the payment execution module 101, but may include the position information acquisition module 102, the advertisement information acquisition module 103, and the display control module 104. The aspect in which the display control system 1 includes only the position information acquisition module 102, the advertisement information acquisition module 103, and the display control module 104 is also within the scope of the present disclosure.

### [Position Information Acquisition Module]

The position information acquisition module 102 acquires the position information on the position of the first store at which the payment based on the user terminal 20 of the user has been executed. In the at least one embodiment, the position information is stored in the store database DB2. Further, the payment request received by the server 10 from the store terminal 30 includes the store identification information. Thus, the position information acquisition module 102 acquires the position information associated with the store identification information included in the payment request based on the store database DB2.

The acquisition method for the position information is not limited to the above-mentioned example. For example, when the store terminal 30 includes a GPS reception unit, the store terminal 30 may detect the position information on the first store based on the own GPS reception unit of the store terminal 30. Moreover, the store terminal 30 may acquire the position information on the first store based on a communication result of the communication unit 33. In this case, the position information acquisition module 102 acquires the position information from the store terminal 30. The store terminal 30 may store the position information in the data storage module 300 in advance.

For example, when the user stays in the first store, the user terminal 20 exists in the first store, and hence the user terminal 20 may acquire the position information on the user terminal 20 as the position information on the first store based on the GPS reception unit 26. Further, the user terminal 20 may acquire the position information on the first store based on a communication result of the communication unit 23. In this case, the position information acquisition module 102 acquires the position information from the user terminal 20.

### [Advertisement Information Acquisition Module]

The advertisement information acquisition module 103 acquires advertisement information on advertisements for the second articles or the second services dealt in at the second stores based on the position information. The second store is another store different from the first store. The second stores are stores being display targets of the advertisements or candidates thereof. In the at least one embodiment, a case in which the second stores are other stores in the neighborhood of the first store is exemplified. The second stores may be other stores which are not in the neighborhood of the first store. The second stores are only required to be other store from which the advertisement information is acquired based on the position information. For example, the second stores may be other stores which may attract interest of residents who reside in an area at the position indicated by the position information.

For example, the advertisement information acquisition module 103 identifies at least one second store being the display target of the advertisement from the plurality of second stores based on the position information. The advertisement information acquisition module 103 acquires the advertisement information on the at least one second store. The advertisement information acquisition module 103 may identify only one second store to acquire the advertisement information on the one second store, or may identify a plurality of second stores to acquire the advertisement information on each of the plurality of second stores. The number of second stores being the display targets of the advertisement may be determined in accordance with the number of advertisement frames set in advance to the payment completion screen SC2.

For example, the advertisement information acquisition module 103 acquires the position information on each of a plurality of stores other than the first store based on the store database DB2. The advertisement information acquisition module 103 calculates a distance from the position indicated by the position information on the first store based on the position information on each of the plurality of other stores. The advertisement information acquisition module 103 identifies, as the second stores, other stores at a distance less than a threshold value (for example, “n” km) from the position indicated by the position information on the first store. The advertisement information acquisition module 103 narrows down the second stores to the display targets of the advertisements when the advertisement information acquisition module 103 identifies a plurality of second stores. For example, the advertisement information acquisition module 103 randomly selects a predetermined number of second stores from the plurality of second stores. The advertisement information acquisition module 103 may select the predetermined number of second stores in ascending order of the distance from the first store. The advertisement information acquisition module 103 may select the predetermined number of second stores in descending order of the distance from the first store.

In the at least one embodiment, the advertisement information is stored in the store database DB2. The advertisement information acquisition module 103 acquires the advertisement information associated with the store identification information on the second stores being the display targets of the advertisement based on the store database DB2. When a plurality of pieces of advertisement information is associated with the second store being the display target of the advertisement, the advertisement information acquisition module 103 narrows down the advertisement information to the display targets based on a predetermined method. For example, the advertisement information acquisition module 103 randomly selects a predetermined number of pieces of advertisement information from the plurality of pieces of advertisement information.

The method of narrowing down the advertisement information may be any method. For example, the advertisement information acquisition module 103 may select advertisement information having a relatively small number of times of display from the plurality of pieces of advertisement information. The advertisement information acquisition module 103 may select advertisement information having a relatively new or old date and time of registration of the advertisement information from the plurality of pieces of advertisement information. When a priority is set to each piece of the advertisement information, the advertisement information acquisition module 103 may select advertisement information having a relatively high priority. Other methods of narrowing down the advertisement information are described in the modification examples described later.

Moreover, the acquisition method for the advertisement information based on the position information is not limited to the example of the at least one embodiment. For example, the advertisement information acquisition module 103 may not identify the second stores in the neighborhood of the first store based on the position information, but may identify second articles or second services which are likely to attract interest of a user in the area at the position indicated by the position information. In this case, the second store dealing in the second articles or the second services is not required to be the store in the neighborhood of the first store. It is assumed that information on the second articles or the second services which are likely to attract interest of the user in this area is stored in the data storage module 100 in advance. The advertisement information acquisition module 103 identifies the second articles or the second services which are likely to attract interest of the user in this area based on this information.

### [Display Control Module]

The display control module 104 displays on the user terminal 20 the payment completion screen SC2 which relates to the completion of the payment, and includes the advertisements indicated by the advertisement information. The display control module 104 is implemented by the server 10, and hence the display control module 104 transmits the display data on the payment completion screen SC2 indicating the payment completion and the advertisements to the user terminal 20, to display the payment completion screen SC2 on the user terminal 20. The display data may be in any format. The display data is only required to be data for displaying a certain screen on the user terminal 20. For example, the display data may be in the HTML format or may be in a data format which the payment application supports.

For example, the display control module 104 generates the display data on the payment completion screen SC2 based on an execution result of the payment by the payment execution module 101 and the advertisement information acquired by the advertisement information acquisition module 103. It is assumed that a program and data required for the generation of the display data are stored in the data storage module 100. For example, the display control module 104 displays on the user terminal 20 the payment completion screen SC2 including the used store used by the user, the amount of use, and content of the advertisements indicated by the advertisement information.

The content of the advertisement may include a link to a webpage for displaying details of the advertisement or a link to a webpage to acquire a coupon indicated by the advertisement. A method of using the coupon itself may be a publicly-known method. When the user selects the advertisement on the payment completion screen SC2, the display control module 104 may display on the user terminal 20 the position information on the second store indicated by the advertisement. For example, when the user selects the advertisement displayed on the payment completion screen SC2 on the lower side of FIG. 2, the display control module 104 may execute guidance display for a path from the first store to the second store on a map as illustrated in FIG. 3. The display control module 104 may display on the payment completion screen SC2 the position information on the second store indicated by the advertisement. For example, the display control module 104 may execute the guidance display for the path from the first store to the second store on the payment completion screen SC2.

### [3-2. Functions Implemented in User Terminal]

For example, the user terminal 20 includes a data storage module 200 and a display control module 201. The data storage module 200 is implemented mainly by the storage unit 22. The display control module 201 is implemented mainly by the control unit 21.

### [Data Storage Module]

The data storage module 200 stores data required for the user to use the payment service. For example, the data storage module 200 stores a payment application or a browser. The code C10 may not be displayed in the payment application, but may be displayed on a browser.

### [Display Control Module]

The display control module 201 displays various screens on the display unit 25. For example, the display control module 201 displays each of the top screen SC1 and the payment completion screen SC2 on the display unit 25.

### [3-3. Functions Implemented in Store Terminal]

For example, the store terminal 30 includes a data storage module 300 and a payment execution module 301. The data storage module 300 is implemented mainly by the storage unit 32. The payment execution module 301 is implemented mainly by the control unit 31.

### [Data Storage Module]

The data storage module 300 stores data required for the payment. For example, the data storage module 300 stores the store identification information on the store terminal 30.

### [Payment Execution Module]

The payment execution module 301 transmits the payment request to the server 10. For example, the payment execution module 301 transmits the payment request to the server 10 based on the user identification information acquired by the reading unit 36 reading the code C10. A method itself of generating the payment request may be a publicly-known method.

### 4. Processing Executed in Display Control System

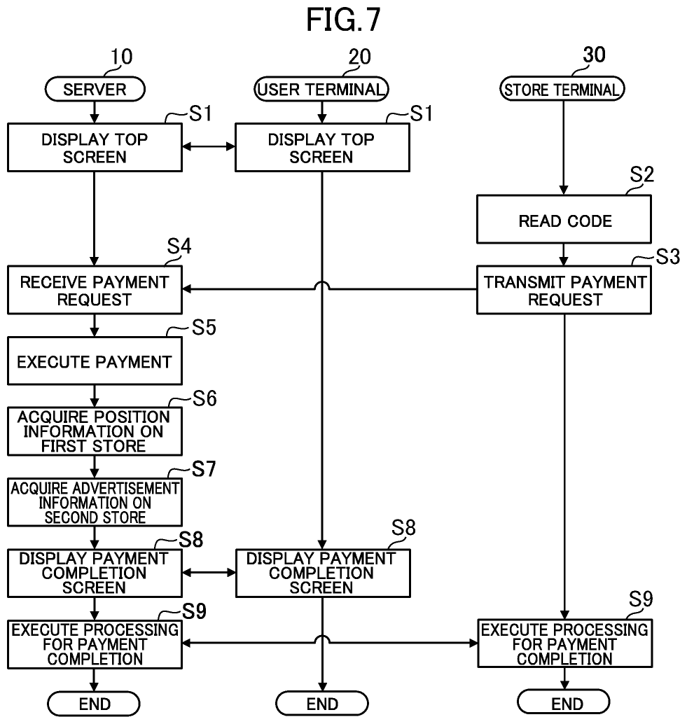

FIG. 7 is a diagram for illustrating an example of processing executed in the image control system 1. The processing of FIG. 7 is executed by the control units 11, 21, and 31 executing programs stored in the storage units 12, 22, and 32, respectively.

As illustrated in FIG. 7, the user terminal 20 starts the payment application based on an operation of the user, to thereby execute processing of displaying the top screen SC1 between the user terminal 20 and the server 10 (Step S1). The store terminal 30 of the first store reads the code C10 through use of the reading unit 36 (Step S2). The store terminal 30 of the first store transmits the payment request to the server 10 based on the user identification information extracted from the code C10 (Step S3). When the server 10 receives the payment request from the store terminal 30 of the first store (Step S4), the server 10 identifies the payment means set by the user as the payment source based on the user database DB1, to thereby execute the payment (Step S5). The server 10 acquires the position information on the first store based on the store database DB2 (Step S6). The server 10 acquires the advertisement information on the second stores based on the store database DB2 and the position information on the first store (Step S7).

The server 10 displays the payment completion screen SC2 including the advertisements indicated by the advertisement information between the server 10 and the user terminal 20 (Step S8). In Step S8, the server 10 generates the display data on the payment completion screen SC2 based on an execution result of the payment in Step S5 and the advertisement information acquired in Step S7 and transmits the display data to the user terminal 20. The user terminal 20 displays the payment completion screen SC2 on the display unit 25 based on the display data received from the server 10. The server 10 executes the processing for the payment completion between the server 10 and the store terminal 30 of the first store (Step S9), and this processing is finished. In Step S9, the server 10 transmits the notification indicating the completion of the payment to the store terminal 30. The store terminal 30 displays the completion of the payment on the display unit 35 based on this notification.

### 5. Summary of at Least One Embodiment

The display control system 1 according to the at least one embodiment acquires the position information on the first store. The display control system 1 acquires advertisement information on the advertisements for the second articles or the second services dealt in at the second stores based on the position information on the first store. The display control system 1 displays on the user terminal 20 the payment completion screen SC2 including the advertisements indicated by the advertisement information. As a result, the user can recognize the second articles or the second services dealt in at the second stores on the payment completion screen SC2, and hence the display control system 1 can effectively urge the user who has used the first store to use the second stores. For example, when the user uses the payment service, the user often cares whether or not the payment has correctly been completed. Thus, the user often carefully views the payment completion screen SC2. The display control system 1 displays advertisements for the second articles or the second services on the payment completion screen SC2 which the user is likely to carefully view, thereby being capable of increasing an advertisement effect. For example, when the display control system 1 displays on the payment completion screen SC2 the advertisements for the second articles or the second services of the second stores existing in the neighborhood of the first store, the display control system 1 can display the advertisements for the second stores to which the user can go soon after the user has used the first store, and hence the advertisement effect can further be increased.

### 6. Modification Examples

The present disclosure is not limited to the above-mentioned at least one embodiment. The present disclosure may appropriately be modified without departing from the purport of the present disclosure.

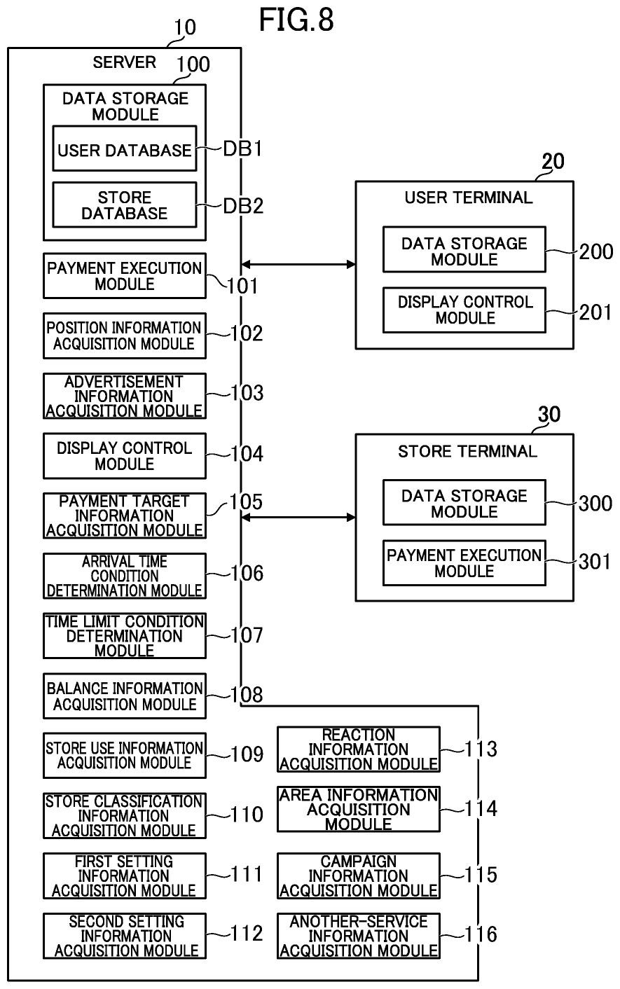

FIG. 8 is a diagram for illustrating an example of functions implemented in the modification examples. As illustrated in FIG. 8, the server 10 in the modification examples includes a payment target information acquisition module 105, an arrival time condition determination module 106, a time limit condition determination module 107, a balance information acquisition module 108, a store use information acquisition module 109, a store classification information acquisition module 110, a first setting information acquisition module 111, a second setting information acquisition module 112, a reaction information acquisition module 113, an area information acquisition module 114, a campaign information acquisition module 115, and an another-service information acquisition module 116. Those functions are implemented by the control unit 11.

### 6-1. Modification Example 1

For example, in the at least one embodiment, the case in which the advertisement information acquisition module 103 acquires the advertisement information based on the position information on the first store is exemplified. The advertisement information acquisition module 103 may acquire the advertisement information in consideration of not only the position information on the first store, but also other information. In Modification Example 1, a case in which the advertisement information acquisition module 103 acquires the advertisement information in consideration of also information on a first article or a first service being the target of the payment at the first store is exemplified. The first article is an article purchased by the user at the first store. The first service is a service which has been used or is to be used by the user at the first store.

The display control system 1 according to Modification Example 1 includes the payment target information acquisition module 105. The payment target information acquisition module 105 acquires payment target information on the first article or the first service being the target of the payment. The payment target information is information which can be used to identify the first article or the first service. The payment target information may be publicly-known information. For example, the payment target information is article identification information (for example, a JAN code, an EAN code other than the JAN code, an original code of the first store, or an article name) on the first article or service identification information (for example, an ID or a name of the service) on the first service. The payment target information may be information which can be used to roughly identify the first article or the first service. For example, the payment target information may be a classification to which the first article or the first service belongs. The classification can also be referred to as “category” or “genre.”

For example, the store terminal 30 acquires the payment target information based on a predetermined acquisition method. The acquisition method itself for the payment target may be a publicly-known method. For example, the store terminal 30 uses the reading unit 36 to read a code (for example, a barcode or a two-dimensional code printed on a label of the article) generated based on the payment target information, to thereby acquire the payment target information. The store terminal 30 may acquire the payment target information input by a shop clerk of the first store from the operation unit 34. The payment target information may be included in the payment request, or may be data independent of the payment request. The payment target information acquisition module 105 acquires the payment target information from the store terminal 30.

When the payment is completed by only the operation on the user terminal 20, the user may use a camera or the like of the user terminal 20 to read a code (for example, a barcode or a two-dimensional code) generated based on the payment target information. The user may also input the payment target information from the operation unit 24 of the user terminal 20. In this case, the payment target information acquisition module 105 may acquire the payment target information from the user terminal 20. The payment target information acquisition module 105 may acquire the payment target information from another computer which acquires the payment target information from the user terminal 20 and the store terminal 30.

The advertisement information acquisition module 103 in Modification Example 1 acquires the advertisement information based further on the payment target information. The advertisement information acquisition module 103 acquires the advertisement information based on the position information on the first store and the payment target information. For example, it is assumed that the advertisement information acquisition module 103 has identified a plurality of second stores based on the position information on the first store. In this case, the advertisement information acquisition module 103 narrows down the plurality of second stores to at least one second store being the display target of the advertisement based on the payment target information.

In Modification Example 1, it is assumed that information which can be used to identify the second articles or the second services is stored in the store database DB2. This information may be publicly-known information. For example, this information is article identification information (for example, a JAN code, an EAN code other than the JAN code, an original code of the second store, or an article name) on the second article or service identification information (for example, an ID or a name of the service) on the second service. This information may be information which can be used to roughly identify the second articles or the second services. For example, this information may be a classification to which the second articles or the second services belong. This information may be included in the advertisement information. The server 10 can use this information to identify which second store deals in which second articles or second services.

For example, the advertisement information acquisition module 103 selects at least one second store which deals in a second article different from the first article indicated by the payment target information or at least one second store which deals in a second service different from the first service indicated by the payment target information from a plurality of second stores. The advertisement information acquisition module 103 acquires the advertisement information on the selected at least one second store.

For example, one certain second store may register advertisement information on each of a plurality of second articles or advertisement information on each of a plurality of second services in the store database DB2. In this case, the advertisement information acquisition module 103 acquires the advertisement information on at least one second article different from the first article indicated by the payment target information from the plurality of second articles. The advertisement information acquisition module 103 acquires the advertisement information on at least one second service different from the first service indicated by the payment target information from the plurality of second services.

The advertisement information acquisition module 103 may acquire, based on the payment target information, the advertisement information on the advertisement for the second article or the second service which tends to be purchased or used in combination with the first article or the first service. That is, the second article different from the first article may be another article which tends to be purchased together with the first article. This another article may be identified by analyzing an article group purchased together by a certain user at a certain store or an article group purchased by a certain user in a predetermined period (for example, within one day). This analysis is sometimes called “basket analysis.” It is assumed that data indicating combinations of articles which tend to be purchased together is stored in the data storage module 100. The server 10 refers to this data, thereby being capable of identifying other articles which tend to be purchased together with the first article.

For example, it is assumed that a user who has purchased diapers at a certain store tends to purchase beer at another store. In this case, when the payment target information indicates diapers, the advertisement information acquisition module 103 acquires advertisement information on beer dealt in at a second store. Moreover, for example, it is assumed that a user who has purchased meat at a certain store tends to purchase vegetables at another store. In this case, when the payment target information indicates meat, the advertisement information acquisition module 103 acquires advertisement information on vegetables dealt in at a second store.

Similarly, the second service different from the first service may be another service which tends to be used together with the first service. This another service may be identified by executing analysis similar to that executed for the another article which tends to be purchased together with the first article. It is assumed that data indicating combinations of services which tend to be used together is stored in the data storage module 100. The server 10 refers to this data, thereby being capable of identifying other services which tend to be used together with the first service.

For example, it is assumed that a user who has had his or her hair cut at a beauty salon tends to get massage at a massage parlor. In this case, when the payment target information indicates haircut, the advertisement information acquisition module 103 acquires advertisement information on massage (for example, advertisement information indicating an advertisement for a specific treatment such as a 30-minute chiropractic course) dealt in at a second store being a massage parlor. Moreover, for example, it is assumed that a user who has his or her nails cared at a nail salon tends to get an esthetic treatment at an esthetic salon. In this case, when the payment target information indicates nail care, the advertisement information acquisition module 103 acquires advertisement information on the esthetic treatment (for example, advertisement information indicating an advertisement for a specific treatment such as a 60-minute aromatherapy course) dealt in at an esthetic salon.

For example, in a case in which a user who has purchased a specific article at a certain store tends to use a specific service at another store, when the first article indicated by the payment target information is this specific article, the advertisement information acquisition module 103 may acquire advertisement information having this specific service as the second service. Conversely, in a case in which a user who has used a specific service at a certain store purchases a specific article at another store, when the first service indicated by the payment target information is this specific service, the advertisement information acquisition module 103 may acquire advertisement information having this specific article as the second article. As described above, the advertisement information on the association between an article and a service may be acquired. The processing by the display control module 104 after the acquisition of the advertisement information is similar to that in the at least one embodiment.

The display control system 1 according to Modification Example 1 acquires the payment target information on the first article or the first service being the target of the payment. The display control system 1 acquires the advertisement information based further on the payment target information. As a result, the display control system 1 can acquire the advertisement information corresponding to the first article or the first service indicated by the payment target information, and hence can more effectively urge the user who has used the first store to use the second stores. For example, the display control system 1 can display on the payment completion screen SC2 the advertisements for the second articles which the user highly probably purchases at the second stores or the second services which the user highly probably uses at the second stores.

Further, the display control system 1 acquires, based on the payment target information, the advertisement information on the advertisement for the second article or the second service which tends to be purchased or used in combination with the first article or the first service. As a result, the display control system 1 can more strongly motivate the user who has used the first store to use the second stores. For example, the user can know the information on the coupons and the like for the second articles or the second services which the user wants to purchase or use together with the first article or the first service, with the result that convenience for the user is increased.

The advertisement information acquisition module 103 may acquire the advertisement information based not on the position information on the first store, but on the payment target information. For example, the advertisement information acquisition module 103 may acquire advertisement information which is on a second store not in the neighborhood of the first store and on second articles or second services different from the first article or the first service indicated by the payment target information. In this case, the display control system 1 does include the position information acquisition module 102. Further, the advertisement information acquisition module 103 does not include the function which considers the position information on the first store. For example, the aspect in which the advertisement information acquisition module 103 acquires the advertisement information based not on the position information on the first store, but on the payment target information is also within the scope of the present disclosure.

### 6-2. Modification Example 2

For example, there are second articles which have long elapsed times after the arrival and second articles which have short elapsed times after the arrival. In this case, the second store may want to sell the second articles which have long elapsed times after the arrival to a user. Thus, the advertisement information acquisition module 103 may acquire the advertisement information in consideration of also the arrival times of the second articles. The arrival time is a time at which the second article is brought into stock. The arrival time may be expressed as a date and time, or may be expressed as only a date.

The display control system 1 according to Modification Example 2 includes the arrival time condition determination module 106. The arrival time condition determination module 106 determines whether or not the arrival time of each of a plurality of the second articles satisfies a predetermined arrival time condition. It is assumed that arrival time information on the arrival times of the second articles is stored in the store database DB2 in Modification Example 2. The arrival time condition determination module 106 acquires the arrival time information on the second articles based on the store database DB2. The arrival time information may be stored in a database other than the store database DB2.

The arrival time condition is a condition relating to the arrival time. In Modification Example 2, a case in which elapse of a predetermined time since the arrival time corresponds to the arrival time condition is exemplified. The arrival time condition may be another condition. For example, the arrival time condition may be such a condition that a predetermined time has not elapsed since the arrival time, such a condition that the arrival time is relatively old, such a condition that the arrival time is relatively new, or another condition.

For example, when a plurality of second stores are identified, the arrival time condition determination module 106 determines, based on the arrival time information on second articles dealt in at each of the plurality of second stores, whether or not each of those second articles satisfies the arrival time condition. In a case in which one certain second store registers the advertisement information on each of a plurality of second articles in the store database DB2, when this second store is identified, the arrival time condition determination module 106 determines, based on the arrival time information on each of the plurality of second articles dealt in at this second store, whether or not this second article satisfies the arrival time condition.

For example, the arrival time condition determination module 106 determines whether or not the predetermined time has elapsed since the arrival time indicated by the arrival time information on the second article. The arrival time condition determination module 106 determines that the second article does not satisfy the arrival time condition when the predetermined time is determined not to have elapsed since its arrival time. The arrival time condition determination module 106 determines that the second article satisfies the arrival time condition when the predetermined time is determined to have elapsed since its arrival time. When another arrival time condition is defined, the arrival time condition determination module 106 may determine whether or not the another arrival time condition is satisfied through use of a determination method corresponding to the another arrival time condition.

The advertisement information acquisition module 103 in Modification Example 2 acquires advertisement information on advertisements for the second articles satisfying the arrival time condition. For example, when a plurality of second stores are identified, the advertisement information acquisition module 103 acquires advertisement information on advertisements of second articles that satisfy the arrival time condition among second articles dealt in at each of the plurality of second stores. When one certain second store registers advertisement information on each of a plurality of second articles in the store database DB2, the advertisement information acquisition module 103 acquires advertisement information on advertisements of second articles that satisfy the arrival time condition among the plurality of second articles. The processing by the display control module 104 after the acquisition of the advertisement information is similar to that in the at least one embodiment.

The display control system 1 according to Modification Example 2 determines whether or not the arrival time of each of the plurality of the second articles satisfies the predetermined arrival time condition. The display control system 1 acquires the advertisement information on the advertisements for the second articles satisfying the arrival time condition. As a result, the display control system 1 can acquire the advertisement information corresponding to the arrival time information, and hence can display the advertisements for the second articles which the second store wants to sell on the payment completion screen SC2. For example, when the display control system 1 displays advertisements for second articles having relatively old arrival times on the payment completion screen SC2, the second store can reduce unsold second articles. When the display control system 1 displays advertisements for second articles having relatively new arrival times on the payment completion screen SC2, the second store can sell the new second articles to the user.

The advertisement information acquisition module 103 may acquire the advertisement information based not on the position information on the first store, but on the advertisement information on the second articles satisfying the arrival time condition. For example, the advertisement information acquisition module 103 may acquire advertisement information on a second store which is not in the neighborhood of the first store and on second articles satisfying the arrival time condition. In this case, the display control system 1 does not include the position information acquisition module 102. Further, the advertisement information acquisition module 103 does not include the function which considers the position information on the first store. For example, an aspect in which the advertisement information acquisition module 103 acquires the advertisement information based not on the position information on the first store, but on the advertisement information on the second articles satisfying the arrival time condition is also within the scope of the present disclosure.

### 6-3. Modification Example 3

For example, time limits, such as a use-by date, a best-before date, an expiration date, or a validity date, may be set to the second article. In this case, the second store may want to sell the second articles which are close to those time limits to the user. Thus, the advertisement information acquisition module 103 may acquire the advertisement information in consideration of also the time limits defined for the second articles. The time limit may be expressed as a date and time, or may be expressed as only a date. In Modification Example 3, a case in which the use-by date corresponds to the time limit is exemplified. The time limit may be another time limit, such as the best-before date, the expiration date, or the validity date.

The display control system 1 according to Modification Example 3 includes the time limit condition determination module 107. The time limit condition determination module 107 determines whether or not the time limit of each of a plurality of the second articles satisfies a predetermined time limit condition. It is assumed that time limit information on the time limit of each of the second articles is stored in the store database DB2 in Modification Example 3. The time limit condition determination module 107 acquires the time limit information on the second articles based on the store database DB2. The time limit information may be stored in a database other than the store database DB2.

The time limit condition is a condition relating to the time limit. In Modification Example 3, a case in which a state in which a time to the time limit (length of a period from the current time to the time limit, which is also considered as a remaining time) is shorter than a predetermined time corresponds to the time limit condition is exemplified. The time limit condition may be another condition. For example, the time limit condition may be such a condition that the time to the time limit is equal to or longer than a predetermined time, such a condition that the time limit is relatively close, such a condition that the time limit is relatively far, or another condition.

For example, when a plurality of second stores are identified, the time limit condition determination module 107 determines, based on the time limit information on second articles dealt in at each of the plurality of second stores, whether or not each of those second articles satisfies the time limit condition. In a case in which one certain second store registers the advertisement information on each of a plurality of second articles in the store database DB2, when this second store is identified, the time limit condition determination module 107 determines, based on the time limit information on each of the plurality of second articles dealt in at this second store, whether or not this second article satisfies the time limit condition.

For example, the time limit condition determination module 107 determines whether or not the time to the time limit indicated by the time limit information on the second article is shorter than a predetermined time. The time limit condition determination module 107 determines that the second article having the time to the time limit determined to be equal to or longer than the predetermined time does not satisfy the time limit condition. The time limit condition determination module 107 determines that the second article having the time to the time limit determined to be shorter than the predetermined time satisfies the time limit condition. When another time limit condition is defined, the time limit condition determination module 107 may determine whether or not the another time limit condition is satisfied through use of a determination method corresponding to the another time limit condition.

The advertisement information acquisition module 103 in Modification Example 3 acquires advertisement information on advertisements for the second articles satisfying the time limit condition. For example, when a plurality of second stores are identified, the advertisement information acquisition module 103 acquires advertisement information on advertisements of second articles that satisfy the time limit condition among second articles dealt in at each of the plurality of second stores. When one certain second store registers advertisement information on each of a plurality of second articles in the store database DB2, the advertisement information acquisition module 103 acquires advertisement information on advertisements of second articles that satisfy the time limit condition among the plurality of second articles. The processing by the display control module 104 after the acquisition of the advertisement information is similar to that in the at least one embodiment.

The display control system 1 according to Modification Example 3 determines whether or not the time limit of each of the plurality of the second articles satisfies a predetermined time limit condition. The display control system 1 acquires the advertisement information on the advertisements for the second articles satisfying the time limit condition. As a result, the display control system 1 can acquire the advertisement information corresponding to the time limit information, and hence can display the advertisements for the second articles which the second store wants to sell on the payment completion screen SC2. For example, when the display control system 1 displays advertisements for second articles having a relatively short time to the time limit on the payment completion screen SC2, the second store can reduce loss of second articles due to the expiration of the time limit. When the display control system 1 displays advertisements for second articles having a relatively long time to the time limit on the payment completion screen SC2, the second store can sell the new second articles to the user.

The advertisement information acquisition module 103 may acquire the advertisement information based not on the position information on the first store, but on the advertisement information on the second articles satisfying the time limit condition. For example, the advertisement information acquisition module 103 may acquire advertisement information on a second store which is not in the neighborhood of the first store and on second articles satisfying the time limit condition. In this case, the display control system 1 does not include the position information acquisition module 102. Further, the advertisement information acquisition module 103 does not include the function which considers the position information on the first store. For example, an aspect in which the advertisement information acquisition module 103 acquires the advertisement information based not on the position information on the first store, but on the advertisement information on the second articles satisfying the time limit condition is also within the scope of the present disclosure.

### 6-4. Modification Example 4

For example, the user may use payment means having a balance in the payment service. In Modification Example 4, a case in which the user uses electronic money in the payment service is exemplified. The payment means having a balance may be payment means other than the electronic money. For example, the payment means having a balance may be reward points, a bank account, an account other than the bank account, or other payment means. In this case, the advertisement information acquisition module 103 may acquire the advertisement information in consideration of also the balance of the payment means of the user.

The display control system 1 according to Modification Example 4 includes the balance information acquisition module 108. The balance information acquisition module 108 acquires balance information on the balance of the payment means that has been used for the payment. It is assumed that the balance information on the payment means of the user is stored in the user database DB1 in Modification Example 4. The balance information acquisition module 108 acquires the balance information on the payment means of the user based on the user database DB1. The balance information may be stored in a database other than the user database DB1. When the user uses the payment means or deposits money to the payment means, the balance information on the payment means of the user is updated.

The advertisement information acquisition module 103 in Modification Example 4 acquires advertisement information on advertisements for second articles or second services each having a price equal to or lower than the balance indicated by the balance information acquired by the balance information acquisition module 108. It is assumed that price information on prices of the second articles or the second services is stored in the store database DB2 in Modification Example 4. The price information may be included in the advertisement information. When the advertisement indicates a coupon, the price information indicates a price after discount. The balance indicated by the balance information is a balance after the payment. The advertisement information acquisition module 103 acquires advertisement information on second articles or second services each having a price equal to or less than the balance indicated by the balance information. The balance information may indicate a sum of balances of a plurality of payment means held by the user.

For example, when a plurality of second stores are identified, the advertisement information acquisition module 103 acquires advertisement information on second articles or second services each of which has a price equal to or lower than the balance indicated by the balance information among second articles or second services dealt in at the plurality of second stores. When one certain second store registers the advertisement information on each of a plurality of second articles or the advertisement information on each of a plurality of second services in the store database DB2, the advertisement information acquisition module 103 acquires advertisement information on advertisements for second articles or second services each of which has a price lower than the balance indicated by the payment information among the plurality of second articles or the plurality of second services. The processing by the display control module 104 after the acquisition of the advertisement information is similar to that in the at least one embodiment.

The display control system 1 according to Modification Example 4 acquires the balance information on the balance of the payment means that has been used for the payment. The display control system 1 acquires the advertisement information on the second articles or the second services each having a price equal to or less than the balance indicated by the balance information. As a result, the display control system 1 can acquire the advertisement information corresponding to the balance indicated by the balance information, and hence can more effectively urge the user who has used the first store to use the second stores. For example, the user can purchase or use the second articles or the second services indicated by the advertisements with use of the current balance, and hence the display control system 1 can motivate the user to use the second stores.

The advertisement information acquisition module 103 acquires the advertisement information on the advertisements for the second articles or the second services each having a price equal to or lower than the balance indicated by the balance information not based on the position information on the first store. For example, the advertisement information acquisition module 103 may acquire advertisement information on second stores not in the neighborhood of the first store and on advertisements for second articles or second services each having a price equal to or lower than the balance indicated by the balance information. In this case, the display control system 1 does include the position information acquisition module 102. Further, the advertisement information acquisition module 103 does not include the function which considers the position information on the first store. For example, the aspect in which the advertisement information acquisition module 103 acquires the advertisement information based not on the position information on the first store, but on the advertisement information on advertisements for second articles or second services each having a price equal to or lower than the balance indicated by the balance information is also within the scope of the present disclosure.

### 6-5. Modification Example 5

For example, among the second stores, there exist second stores which have a relatively high possibility of use by the user. Such second stores may be identified based on a use situation of stores by the user or a use situation of stores by another user similar to the user. The another user is another user having the same attribute (for example, an age group, a residential area, or a hobby) as that of the user. The another user may be identified through use of collaborative filtering. Thus, the advertisement information acquisition module 103 may acquire the advertisement information in consideration of not only the position information on the first store, but also the use situation of stores by the user or the another user.

The display control system 1 according to Modification Example 5 includes the store use information acquisition module 109. The store use information acquisition module 109 acquires store use information on the use of stores by the user or the another user. The store use information indicates the use situation (use history) of stores by the user or the another user. For example, the store use information indicates store identification information on stores which the user or the another user has visited, articles purchased by the user or the another user in the stores, services used by the user or the another user in the stores, an amount of use, a date and time of use, or a combination thereof.

It is assumed that the store use information on each of a plurality of users is stored in the user database DB1 in Modification Example 5. The store use information acquisition module 109 acquires the store use information on the user or the another user based on the user database DB1. When the user or the another user uses a store, the store use information indicating the use situation in this store is stored in the user database DB1 in association with the user identification information on the user or the another user. The store use information may be stored in a database other than the user database DB1.

The advertisement information acquisition module 103 in Modification Example 5 acquires the advertisement information based further on the store use information. The advertisement information acquisition module 103 acquires the advertisement information based on the position information on the first store and the store use information. For example, it is assumed that the advertisement information acquisition module 103 identifies a plurality of second stores based on the position information on the first store. In this case, the advertisement information acquisition module 103 narrows down the plurality of second stores to at least one second store being the display target of the advertisement based on the store use information.

For example, the advertisement information acquisition module 103 selects at least one second store which the user or the another user has used based on the store use information from a plurality of second stores. At least one second store in the same classification as that of the store which the user or the another user has used may be selected based on the store use information. The advertisement information acquisition module 103 acquires the advertisement information on the selected at least one second store. The processing by the display control module 104 after the acquisition of the advertisement information is similar to that in the at least one embodiment.

The method of acquiring the advertisement information by the advertisement information acquisition module 103 is not limited to the above-mentioned example. For example, the advertisement information acquisition module 103 may not acquire advertisement information on second stores which the user or the another user has visited before the first store, and may acquire advertisement information on second stores which the user or the another user has not visited before the first store. Moreover, for example, the user or the another user may periodically visit the same store. In this case, the advertisement information acquisition module 103 may not acquire advertisement information on second stores each having a time elapsed since the visit of the user or the another user shorter than a predetermined time, and may acquire advertisement information on second stores each having a time elapsed since the visit of the user or the another user equal to or longer than the predetermined time.

For example, one certain second store may register advertisement information on each of a plurality of second articles or advertisement information on each of a plurality of second services in the store database DB2. In this case, the advertisement information acquisition module 103 selects at least one same second article as an article the user or the another user has purchased or at least one same second service as a service the user or the another user has used from the plurality of second articles or the plurality of second services based on the store use information. The advertisement information acquisition module 103 acquires the advertisement information on the selected at least one second article or second service.

The method of acquiring the advertisement information by the advertisement information acquisition module 103 is not limited to the above-mentioned example. For example, the advertisement information acquisition module 103 may not acquire the advertisement information on the same second article or second service as that the user or the another user purchased or used before the first store, but advertisement information on a second article or second service different from the second article or the second service which the user or the another user purchased or used before the first store. Moreover, for example, the user or the another user may periodically purchase the same article or use the same service. In this case, the advertisement information acquisition module 103 may not acquire advertisement information on second articles or second services each having an elapsed time since the purchase or the use by the user or the another user shorter than a predetermined time, and may acquire advertisement information on second articles or second services each having an elapsed time since the purchase or the use by the user or the another user equal to or longer than the predetermined time.

The display control system 1 according to Modification Example 5 acquires the store use information on the use of stores by the user or the another user. The display control system 1 acquires the advertisement information based further on the store use information. As a result, the display control system 1 can acquire the advertisement information corresponding to the use situation indicated by the store use information, and hence can more effectively urge the user who has used the first store to use the second stores. For example, the display control system 1 can display on the payment completion screen SC2 advertisements for second articles or second services of second stores which the user highly probably visits after the first store. For example, the display control system 1 can display on the payment completion screen SC2 the advertisements for the second articles which the user highly probably purchases at the second stores or the second services which the user highly probably uses at the second stores.

The advertisement information acquisition module 103 may acquire the advertisement information based not on the position information on the first store, but on the store use information. For example, the advertisement information acquisition module 103 may acquire advertisement information on a second store which is not in the neighborhood of the first store and corresponds to the use situation indicated by the store use information. In this case, the display control system 1 does include the position information acquisition module 102. Further, the advertisement information acquisition module 103 does not include the function which considers the position information on the first store. For example, an aspect in which the advertisement information acquisition module 103 acquires the advertisement information based not on the position information on the first store, but on the store use information is also within the scope of the present disclosure.

### 6-6. Modification Example 6

For example, a probability that the user successively visits similar stores is low. Thus, the advertisement information acquisition module 103 may acquire the advertisement information in consideration of also the classification of the first store. For example, the classifications are business types, such as supermarket, convenience store, drug store, and restaurant. The classification can also be referred to as category or genre of the store.

The display control system 1 according to Modification Example 6 includes the store classification information acquisition module 110. The store classification information acquisition module 110 acquires store classification information on the classification of the first store. It is assumed that the store classification information on the classification of each of a plurality of stores is stored in the store database DB2 in Modification Example 6. The store classification information acquisition module 110 acquires the store classification information on the first store based on the store database DB2. The store classification information may be stored in a database other than the store database DB2.

The advertisement information acquisition module 103 in Modification Example 6 acquires the advertisement information based further on the store classification information. The advertisement information acquisition module 103 acquires the advertisement information based on the position information on the first store and the store classification information. For example, it is assumed that the advertisement information acquisition module 103 has identified a plurality of second stores based on the position information on the first store. In this case, the advertisement information acquisition module 103 narrows down the plurality of second stores to at least one second store being the display target of the advertisement based on the store classification information.

For example, the advertisement information acquisition module 103 selects at least one second store in a classification different from the classification indicated by the store classification information from a plurality of second stores. The advertisement information acquisition module 103 acquires the advertisement information on the selected at least one second store. When a store in a specific classification tends to be used after a store in a certain classification is used, the advertisement information acquisition module 103 selects, from a plurality of second stores, at least one second store in the specific classification associated with the classification indicated by the store classification information. In this case, it is assumed that the associations between the classifications are defined in advance in the data storage module 100. The processing by the display control module 104 after the acquisition of the advertisement information is similar to that in the at least one embodiment.

The display control system 1 according to Modification Example 6 acquires the store classification information on the classification of the first store. The display control system 1 acquires the advertisement information based further on the store classification information. As a result, the display control system 1 can acquire the advertisement information in accordance with the classification indicated by the store classification information, and hence can more effectively urge the user who has used the first store to use the second stores. For example, the display control system 1 can display on the payment completion screen SC2 advertisements for second stores which the user highly probably visits after the first store.

The advertisement information acquisition module 103 may acquire the advertisement information based not on the position information on the first store, but on the store classification information. For example, the advertisement information acquisition module 103 may acquire advertisement information on a second store which is not in the neighborhood of the first store and corresponds to the classification indicated by the store classification information. In this case, the display control system 1 does not include the position information acquisition module 102. Further, the advertisement information acquisition module 103 does not include the function which considers the position information on the first store. For example, an aspect in which the advertisement information acquisition module 103 acquires the advertisement information based not on the position information on the first store, but on the store classification information is also within the scope of the present disclosure.

### 6-7. Modification Example 7

For example, the first store may want to hide specific advertisements from the user who has used the first store. The first store may want to hide advertisements on second stores in the same classification as that of the first store from the user who has used the first store. The first store may also want to hide an advertisement for the same second article as the first article or an advertisement for the same second service as the first service from the user who has used the first store. Thus, the first store may be allowed to specify a setting of the advertisement for the user who has used the first store.

The display control system 1 includes the first setting information acquisition module 111. The first setting information acquisition module 111 acquires first setting information on the setting for the advertisement specified by the first store. It is assumed that the first setting information on each of a plurality of stores is stored in the store database DB2 in Modification Example 7. The first setting information acquisition module 111 acquires the first setting information on the first store based on the store database DB2. The first setting information may be stored in a database other than the store database DB2.

The first setting information may indicate a setting for advertisements which the first store wants to hide from the user or a setting for advertisements which the first store wants to present to the user. For example, the first setting information may be the store identification information on the second stores, the classifications of the second stores, the article identification information on the second articles, the classifications of the second articles, the service identification information on the second services, the classifications of the second services, the price ranges of the second articles or the second services, or a combination thereof.

The advertisement information acquisition module 103 in Modification Example 7 acquires the advertisement information based further on the first setting information. The advertisement information acquisition module 103 acquires the advertisement information based on the position information on the first store and the first setting information. For example, it is assumed that the advertisement information acquisition module 103 has identified a plurality of second stores based on the position information on the first store. In this case, the advertisement information acquisition module 103 narrows down the plurality of second stores to at least one second store being the display target of the advertisement based on the first setting information.

For example, when the first setting information indicates second stores advertisements for which the first store wants to hide from the user, the advertisement information acquisition module 103 selects, from a plurality of second stores, at least one second store other than the second stores indicated by the first setting information. When the first setting information indicates the classifications of the second stores advertisements for which the first store wants to hide, the advertisement information acquisition module 103 selects, from a plurality of second stores, at least one second store in classifications other than those classifications. The advertisement information acquisition module 103 acquires the advertisement information on the selected at least one second store.

For example, when the first setting information indicates second stores advertisements for which the first store wants to present to the user, the advertisement information acquisition module 103 selects, from a plurality of second stores, at least one second store indicated by the first setting information. When the first setting information indicates the classifications of the second stores advertisements for which the first store wants to present to the user, the advertisement information acquisition module 103 selects, from a plurality of second stores, at least one second store in those classifications. The advertisement information acquisition module 103 acquires the advertisement information on the selected at least one second store. When the first setting information indicates another setting, the advertisement information acquisition module 103 is only required to similarly acquire the advertisement information corresponding to the first setting information. The processing by the display control module 104 after the acquisition of the advertisement information is similar to that in the at least one embodiment.

The display control system 1 according to Modification Example 7 acquires the first setting information on the setting for the advertisement specified by the first store. The display control system 1 acquires the advertisement information based further on the first setting information. As a result, the display control system 1 can acquire the advertisement information corresponding to the first setting information, and hence can prevent an advertisement not intended by the first store from being displayed on the payment completion screen SC2 of the user who has used the first store. For example, the display control system 1 can prevent advertisements for second articles or second services dealt in at second stores being rivals of the first store from being displayed on the payment completion screen SC2 of the user who has used the first store. Conversely, the display control system 1 can display advertisements for second articles or second services dealt in at second stores cooperating with the first store on the payment completion screen SC2 of the user who has used the first store.

The advertisement information acquisition module 103 may acquire the advertisement information based not on the position information on the first store, but on the first setting information. For example, the advertisement information acquisition module 103 may acquire advertisement information on a second store which is not in the neighborhood of the first store, the advertisement information corresponding to the first setting information. In this case, the display control system 1 does not include the position information acquisition module 102. Further, the advertisement information acquisition module 103 does not include the function which considers the position information on the first store. For example, an aspect in which the advertisement information acquisition module 103 acquires the advertisement information based not on the position information on the first store, but on the first setting information is also within the scope of the present disclosure.

### 6-8. Modification Example 8

For example, the second store may want to hide an advertisement for the second store from the user who has used a specific first store. The second store may consider that presentation of an advertisement for the second store to a user who has used a first store in a classification irrelevant to the second store is not effective as the advertisement. The second store may consider that presentation of an advertisement for the second store to a user who has purchased or used the same first article or first service as a second article or a second service is not effective as the advertisement. Thus, the second store may be allowed to specify a setting of the advertisement to the user who has used the first store.

The display control system 1 according to Modification Example 8 includes the second setting information acquisition module 112. The second setting information acquisition module 112 acquires second setting information on the setting for the advertisement specified by the second store. It is assumed that the second setting information on each of a plurality of stores is stored in the store database DB2 in Modification Example 8. The second setting information acquisition module 112 acquires the second setting information on the second store based on the store database DB2. The second setting information may be stored in a database other than the store database DB2.

The second setting information may indicate a setting for advertisements which the second store wants to hide from the user or a setting for advertisements which the second store wants to present to the user. For example, the second setting information may be the store identification information on the first stores, the classifications of the first stores, the article identification information on the first articles, the classifications of the first articles, the service identification information on the first services, the classifications of the first services, the price ranges of the first articles or the first services, or a combination thereof.

The advertisement information acquisition module 103 in Modification Example 8 acquires the advertisement information based further on the second setting information. The advertisement information acquisition module 103 acquires the advertisement information based on the position information on the first store and the second setting information. For example, it is assumed that the advertisement information acquisition module 103 has identified a plurality of second stores based on the position information on the first store. In this case, the advertisement information acquisition module 103 narrows down the plurality of second stores to at least one second store being the display target of the advertisement based on the second setting information.

For example, when the second setting information indicates first stores advertisements for which the second store wants to hide from the user, the advertisement information acquisition module 103 selects, from a plurality of second stores, at least one second store for which the first stores are not indicated by the second setting information. When the second setting information indicates the classifications of the first stores advertisements for which the second store wants to hide, the advertisement information acquisition module 103 selects, from a plurality of second stores, at least one second store for which the classifications of the first stores are not indicated by the second setting information. The advertisement information acquisition module 103 acquires the advertisement information on the selected at least one second store.

For example, when the second setting information indicates first stores advertisements for which the second store wants to present to the user, the advertisement information acquisition module 103 selects, from a plurality of second stores, at least one second store for which the first stores are indicated by the second setting information. When the second setting information indicates the classifications of the first stores advertisements for which the second store wants to present to the user, the advertisement information acquisition module 103 selects, from a plurality of second stores, at least one second store for which the classifications of the first stores are indicated by the second setting information. The advertisement information acquisition module 103 acquires the advertisement information on the selected at least one second store. When the second setting information indicates another setting, the advertisement information acquisition module 103 is only required to similarly acquire the advertisement information corresponding to the second setting information. The processing by the display control module 104 after the acquisition of the advertisement information is similar to that in the at least one embodiment.

The display control system 1 according to Modification Example 8 acquires the second setting information on the setting for the advertisement specified by the second store. The display control system 1 acquires the advertisement information based further on the second setting information. As a result, the display control system 1 can acquire the advertisement information corresponding to the second setting information, and hence can prevent an advertisement not intended by the second store from being displayed on the payment completion screen SC2 of the user who has used the first store. For example, the display control system 1 can prevent advertisements for second articles or second services which the second stores consider to have low advertisement effects from being displayed on the payment completion screen SC2 of the user who has used the first store. Conversely, the display control system 1 can display advertisements for second articles or second services which the second stores consider to have high advertisement effects on the payment completion screen SC2 of the user who has used the first store.

The advertisement information acquisition module 103 may acquire the advertisement information based not on the position information on the first store, but on the second setting information. For example, the advertisement information acquisition module 103 may acquire advertisement information on a second store which is not in the neighborhood of the first store, the advertisement information corresponding to the second setting information. In this case, the display control system 1 does not include the position information acquisition module 102. Further, the advertisement information acquisition module 103 does not include the function which considers the position information on the first store. For example, an aspect in which the advertisement information acquisition module 103 acquires the advertisement information based not on the position information on the first store, but on the second setting information is also within the scope of the present disclosure.

### 6-9. Modification Example 9

For example, the user may be allowed to react to the advertisements displayed on the payment completion screen SC2. The reaction itself may be publicly-known various reactions. For example, the reaction may be “like”, “share” in social media, “share” which uses of a medium such as an electronic mail other than the social media, or another reaction. An advertisement receiving many reactions is possibly highly effective as the advertisement, and hence the advertisement information acquisition module 103 may acquire the advertisement information in consideration of not only the position information on the first store, but also the reactions to the advertisement.

The display control system 1 according to Modification Example 9 includes the reaction information acquisition module 113. The reaction information acquisition module 113 acquires reaction information on reactions to each of a plurality of advertisements. It is assumed that reaction information on reactions to advertisements is stored in the store database DB2 in Modification Example 9. When a certain user reacts to an advertisement, the reaction information is updated such that the number of reactions to this advertisement increases. The reaction information indicates not only the number of reactions, but also other information, such as information on a user who reacts and a date and time of the reaction. The reaction information may be stored in a database other than the store database DB2.

The advertisement information acquisition module 103 in Modification Example 9 acquires the advertisement information based further on the reaction information. The advertisement information acquisition module 103 acquires the advertisement information based on the position information on the first store and the reaction information. For example, it is assumed that the advertisement information acquisition module 103 has identified a plurality of second stores based on the position information on the first store. In this case, the advertisement information acquisition module 103 narrows down the plurality of second stores to at least one second store being the display target of the advertisement based on the reaction information.

For example, the advertisement information acquisition module 103 selects at least one second store having a relatively large number of reactions indicated by the reaction information. The advertisement information acquisition module 103 may select a predetermined number of second stores in descending order of the number of reactions indicated by the reaction information, or may select second stores having the number of reactions which is indicated by the reaction information and is equal to or larger than a threshold value. The advertisement information acquisition module 103 acquires the advertisement information on the selected at least one second store.

For example, one certain second store may register advertisement information on each of a plurality of second articles or advertisement information on each of a plurality of second services in the store database DB2. In this case, the advertisement information acquisition module 103 may select at least one second article or second service based on the reaction information on each of the plurality of second articles or the reaction information on each of the plurality of second services. For example, the advertisement information acquisition module 103 may select a second article or a second service having a relatively large number of reactions indicated by the reaction information. The advertisement information acquisition module 103 acquires the advertisement information on the selected at least one second article or second service. The processing by the display control module 104 after the acquisition of the advertisement information is similar to that in the at least one embodiment.

The display control system 1 according to Modification Example 9 acquires the reaction information on reactions to each of a plurality of advertisements. The display control system 1 acquires the advertisement information based further on the reaction information. As a result, the display control system 1 can display advertisements having high advertisement effects on the payment completion screen SC2. For example, the display control system 1 can display advertisements to which more users react on the payment completion screen SC2.

The advertisement information acquisition module 103 may acquire the advertisement information based not on the position information on the first store, but on the reaction information. For example, the advertisement information acquisition module 103 may acquire advertisement information on a second store which is not in the neighborhood of the first store, the advertisement information corresponding to the reaction information. In this case, the display control system 1 does not include the position information acquisition module 102. Further, the advertisement information acquisition module 103 does not include the function which considers the position information on the first store. For example, an aspect in which the advertisement information acquisition module 103 acquires the advertisement information based not on the position information on the first store, but on the reaction information is also within the scope of the present disclosure.

### 6-10. Modification Example 10

For example, when the first store exists in a city center, the second store highly possibly exists in the neighborhood of the first store. Meanwhile, when the first store exists in a suburb, the second store may not exist in the neighborhood of the first store. Thus, the advertisement information acquisition module 103 may acquire the advertisement information in consideration of an area of the first store. The area is a region having a certain degree of size. In Modification Example 10, a case in which the area is indicated by binary values corresponding to the city center and the suburb is exemplified, but the area may be another division, such as a prefecture or a city.

The display control system 1 according to Modification Example 10 includes the area information acquisition module 114. The area information acquisition module 114 acquires area information on the area of the first store. It is assumed that the area information on each of a plurality of stores is stored in the store database DB2 in Modification Example 10. The position information and the area information are different from each other in such a point that while the position information indicates a certain pinpoint position, the area information indicates a region having a certain degree of size. Even when a certain store and another store are different from each other in position information, those stores may be the same in area information.

The advertisement information acquisition module 103 in Modification Example 10 acquires the advertisement information based further on the area information. The advertisement information acquisition module 103 acquires the advertisement information based on the position information on the first store and the area information. For example, the advertisement information acquisition module 103 acquires a threshold value (the value of “n” in the at least one embodiment) for identifying second stores based on the area information on the first store. The advertisement information acquisition module 103 acquires a larger threshold value when the area information on the first store indicates the suburb than that when the area information on the first store indicates the city center. The advertisement information acquisition module 103 identifies second stores based on the position information on the first store and the acquired threshold value. The advertisement information acquisition module 103 acquires the advertisement information on the identified second stores. The processing by the display control module 104 after the acquisition of the advertisement information is similar to that in the at least one embodiment.

The display control system 1 according to Modification Example 10 acquires the area information on the area of the first store. The display control system 1 acquires the advertisement information based further on the area information. As a result, the display control system 1 can display advertisements corresponding to the area of the first store on the payment completion screen SC2.

The advertisement information acquisition module 103 may acquire the advertisement information based not on the position information on the first store, but on the area information. For example, the advertisement information acquisition module 103 may acquire advertisement information on a second store which is not in the neighborhood of the first store, the advertisement information corresponding to the area information. In this case, the display control system 1 does not include the position information acquisition module 102. Further, the advertisement information acquisition module 103 does not include the function which considers the position information on the first store. For example, an aspect in which the advertisement information acquisition module 103 acquires the advertisement information based not on the position information on the first store, but on the area information is also within the scope of the present disclosure.

### [6-11. Modification Example 11]

For example, the first store may want to hide, from the user who has used the first store, advertisements for second articles or second services relating to a campaign held by the first store. When the first store is a convenience store, the first store may not care when an advertisement for a second article or a second service of a second store being a curry restaurant different in business type from the convenience store is displayed on the payment completion screen SC2 in a usual period. Meanwhile, when the advertisement for the second store is displayed on the payment completion screen SC2 in a period in which the first store holds a campaign relating to curry, the advertisement competing with the campaign of the first store is presented to the user. Thus, the advertisement information acquisition module 103 may acquire the advertisement information in consideration of the campaign held at the first store.

The display control system 1 according to Modification Example 11 includes the campaign information acquisition module 115. The campaign information acquisition module 115 acquires the campaign information on the campaign held at the first store. The campaign information indicates a period in which the campaign is held, articles or services being targets of the campaign, second stores or classifications thereof advertisements for which are to be hidden during the campaign, second articles or second services advertisements for which are to be hidden during the campaign, second stores or classifications thereof advertisements for which are to be displayed during the campaign, second articles or second services advertisements for which are to be displayed during the campaign, and other information.

The advertisement information acquisition module 103 in Modification Example 11 acquires the advertisement information based further on the campaign information. The advertisement information acquisition module 103 acquires the advertisement information based on the position information on the first store and the campaign information. For example, it is assumed that the advertisement information acquisition module 103 has identified a plurality of second stores based on the position information on the first store. In this case, the advertisement information acquisition module 103 narrows down the plurality of second stores to at least one second store being the display target of the advertisement based on the campaign information.

For example, the advertisement information acquisition module 103 selects at least one second store which does not deal in the articles or the services which are the targets of the campaign indicated by the campaign information from a plurality of second stores. Moreover, for example, the advertisement information acquisition module 103 selects, from the plurality of second stores, at least one second store other than the second stores or the classifications thereof advertisements for which are to be hidden during the campaign indicated by the campaign information. Whether or not the campaign is being held is determined based on whether or not the current time belongs to the campaign period indicated by the campaign information. The advertisement information acquisition module 103 acquires the advertisement information on the selected at least one second store. The advertisement information acquisition module 103 may acquire advertisement information corresponding to other content indicated by the campaign information. The processing by the display control module 104 after the acquisition of the advertisement information is similar to that in the at least one embodiment.

The display control system 1 according to Modification Example 11 acquires the campaign information on the campaign held at the first store. The display control system 1 acquires the advertisement information based further on the campaign information. As a result, the display control system 1 can acquire the advertisement information corresponding to the campaign information, and hence can more effectively urge the user who has used the first store to use the second stores. The display control system 1 can prevent such an incident that an advertisement obstructing the campaign of the first store is displayed on the payment completion screen SC2.

The advertisement information acquisition module 103 may acquire the advertisement information based not on the position information on the first store, but on the campaign information. For example, the advertisement information acquisition module 103 may acquire advertisement information on a second store which is not in the neighborhood of the first store, the advertisement information corresponding to the campaign information. In this case, the display control system 1 does not include the position information acquisition module 102. Further, the advertisement information acquisition module 103 does not include the function which considers the position information on the first store. For example, an aspect in which the advertisement information acquisition module 103 acquires the advertisement information based not on the position information on the first store, but on the campaign information is also within the scope of the present disclosure.

### [6-12. Modification Example 12]

For example, in Modification Example 5, the case in which the advertisement information is acquired in consideration of the use situation of the store by the user or another user is exemplified. An action of the user or the another user is often informative for the acquisition of the advertisement information. For example, an action of the user or the another user in a service other than the payment service may be used. The another service may be any service. For example, the another service may be an electronic commerce service, a travel reservation service, a financial service, a reward point service, a communication service, or another service.

The display control system 1 according to Modification Example 12 includes the another-service information acquisition module 116. The another-service information acquisition module 116 acquires another-service information on a use situation of the user or the another user of the another service different from the payment service relating to the payment. The another-service information indicates the use situation (use history) of the another service by the user or the another user. For example, the another-service information indicates articles purchased in the another service, services used in the another service, an amount of use, a date and time of use, or a combination thereof.

It is assumed that the another-service information on each of a plurality of users is stored in the user database DB1 in Modification Example 12. The another-service information acquisition module 116 acquires the another-service information on the user or the another user based on the user database DB1. When the user or the another user uses the another service, the another-service information indicating the use situation in a store at which the user or the another user has used the another service is stored in the user database DB1 in association with the user identification information on the user or the another user. The another-service information may be stored in a database other than the user database DB1.

The advertisement information acquisition module 103 in Modification Example 12 acquires the advertisement information based further on the another-service information. The advertisement information acquisition module 103 acquires the advertisement information based on the position information on the first store and the another-service information. For example, it is assumed that the advertisement information acquisition module 103 has identified a plurality of second stores based on the position information on the first store. In this case, the advertisement information acquisition module 103 narrows down the plurality of second stores to at least one second store being the display target of the advertisement based on the another-service information.

For example, the advertisement information acquisition module 103 selects, from a plurality of second stores, at least one second store which deals in second articles different from the article indicated by the another-service information or at least one second store which deals in second services different from the service indicated by the another-service information. The advertisement information acquisition module 103 may select, from a plurality of second stores, at least one second store which deals in the same second articles as the articles indicated by the another-service information or at least one second store which deals in the same second services as the services indicated by the another-service information. The advertisement information acquisition module 103 acquires the advertisement information on the selected at least one second store.

For example, one certain second store may register advertisement information on each of a plurality of second articles or advertisement information on each of a plurality of second services in the store database DB2. In this case, the advertisement information acquisition module 103 acquires advertisement information on at least one second article different from the articles indicated by the another-service information from the plurality of second articles. The advertisement information acquisition module 103 acquires advertisement information on at least one second service different from the services indicated by the another-service information from the plurality of second services. The advertisement information acquisition module 103 may acquire advertisement information on at least one second article that is the same as the articles indicated by the another-service information from the plurality of second articles. The advertisement information acquisition module 103 may acquire the advertisement information on at least one second service that is the same as the services indicated by the another-service information from the plurality of second services. The processing by the display control module 104 after the acquisition of the advertisement information is similar to that in the at least one embodiment.

The display control system 1 according to Modification Example 12 acquires the another-service information on the use situation of the user or the another user of the another service different from the payment service relating to the payment. The display control system 1 acquires the advertisement information based further on the another-service information. As a result, the display control system 1 can acquire the advertisement information corresponding to the use situation indicated by the another-service information, and hence can more effectively urge the user who has used the first store to use the second stores.

The advertisement information acquisition module 103 may acquire the advertisement information based not on the position information on the first store, but on the another-service information. For example, the advertisement information acquisition module 103 may acquire advertisement information on a second store which is not in the neighborhood of the first store, the advertisement information corresponding to the use situation indicated by the another-service information. In this case, the display control system 1 does not include the position information acquisition module 102. Further, the advertisement information acquisition module 103 does not include the function which considers the position information on the first store. For example, an aspect in which the advertisement information acquisition module 103 acquires the advertisement information based not on the position information on the first store, on but the another-service information is also within the scope of the present disclosure.

### 6-13. Other Modification Examples

For example, the modification examples described above may be combined with one other. For example, in the at least one embodiment and Modification Example 1 to Modification Example 12, the processing of acquiring, by the advertisement information acquisition module 103, the advertisement information based on the various conditions has been described. A combination of the conditions described in the at least one embodiment and Modification Example 1 to Modification Example 12 may be any combination. The advertisement information acquisition module 103 may acquire the advertisement information under an AND condition or an OR condition of a plurality of conditions freely selected from the plurality of conditions described in the at least one embodiment and Modification Example 1 to Modification Example 12.

For example, the processing described as being executed by the server 10 may be executed by the user terminal 20 or the store terminal 30. The processing described as being executed by the user terminal 20 may be executed by the server 10 or the store terminal 30. The processing described as being executed by the store terminal 30 may be executed by the server 10 or the user terminal 20. The processing described as being executed by the server 10, the store terminal 30, or the user terminal 20 may be distributed to a plurality of computers.

### 7. Supplementary Notes

For example, the display control system may have the following configurations.
(1)
A display control system in accordance with position information, the display control system including:
a position information acquisition module configured to acquire position information on a position of a first store at which payment based on a user terminal of a user has been executed;
an advertisement information acquisition module configured to acquire advertisement information on an advertisement for one of a second article or a second service dealt in at a second store based on the position information; and
a display control module configured to display on the user terminal a payment completion screen that relates to completion of the payment and includes the advertisement indicated by the advertisement information.
(2)
The display control system according to Item (1), further including a payment target information acquisition module configured to acquire payment target information on one of a first article or a first service being a target of the payment,
wherein the advertisement information acquisition module is configured to acquire the advertisement information based further on the payment target information.
(3)
The display control system according to Item (2), wherein the advertisement information acquisition module is configured to acquire, based on the payment target information, the advertisement information on the advertisement for one of the second article or the second service which tends to be purchased or used in combination with one of the first article or the first service.
(4)
The display control system according to any one of Items (1) to (3), further including an arrival time condition determination module configured to determine whether an arrival time of each of a plurality of the second articles satisfies a predetermined arrival time condition,
wherein the advertisement information acquisition module is configured to acquire the advertisement information on the advertisement for one of the plurality of the second articles that satisfies the predetermined arrival time condition.
(5)
The display control system according to any one of Items (1) to (4), further including a time limit condition determination module configured to determine whether a time limit of each of a plurality of the second articles satisfies a predetermined time limit condition,
wherein the advertisement information acquisition module is configured to acquire the advertisement information on the advertisement for one of the plurality of the second articles that satisfies the predetermined time limit condition.
(6)
The display control system according to any one of Items (1) to (5), further including a balance information acquisition module configured to acquire balance information on a balance of payment means that has been used in the payment,
wherein the advertisement information acquisition module is configured to acquire the advertisement information on the advertisement for one of the second article or the second service having a price equal to or lower than the balance indicated by the balance information.
(7)
The display control system according to any one of Items (1) to (6), further including a store use information acquisition module configured to acquire store use information on use of a store by one of the user or another user,
wherein the advertisement information acquisition module is configured to acquire the advertisement information based further on the store use information.
(8)
The display control system according to any one of Items (1) to (7), further including a store classification information acquisition module configured to acquire store classification information on a classification of the first store,
wherein the advertisement information acquisition module is configured to acquire the advertisement information based further on the store classification information.
(9)
The display control system according to any one of Items (1) to (8), further including a first setting information acquisition module configured to acquire first setting information on a setting of the advertisement specified by the first store,
wherein the advertisement information acquisition module is configured to acquire the advertisement information based further on the first setting information.
(10)
The display control system according to any one of Items (1) to (9), further including a second setting information acquisition module configured to acquire second setting information on a setting of the advertisement specified by the second store,
wherein the advertisement information acquisition module is configured to acquire the advertisement information based further on the second setting information.
(11)
The display control system according to any one of Items (1) to (10), further including a reaction information acquisition module configured to acquire reaction information on a reaction to each of a plurality of the advertisements,
wherein the advertisement information acquisition module is configured to acquire the advertisement information based further on the reaction information.
(12)
The display control system according to any one of Items (1) to (11), further including an area information acquisition module configured to acquire area information on an area of the first store,
wherein the advertisement information acquisition module is configured to acquire the advertisement information based further on the area information.
(13)
The display control system according to any one of Items (1) to (12), further including a campaign information acquisition module configured to acquire campaign information on a campaign held at the first store,
wherein the advertisement information acquisition module is configured to acquire the advertisement information based further on the campaign information.
(14)
The display control system according to any one of Items (1) to (13), further including an another-service information acquisition module configured to acquire another-service information on a use situation of one of the user or another user of another service different from a payment service relating to the payment,
wherein the advertisement information acquisition module is configured to acquire the advertisement information based further on the another-service information.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display control system in accordance with position information, the display control system comprising at least one processor configured to:
acquire position information on a position of a first store at which payment based on a user terminal of a user has been executed;
acquire advertisement information on an advertisement for one of a second article or a second service dealt in at a second store based on the position information; and
display on the user terminal a payment completion screen that relates to completion of the payment and includes the advertisement indicated by the advertisement information.

2. The display control system according to claim 1, wherein the at least one processor is configured to:
acquire payment target information on one of a first article or a first service being a target of the payment; and
acquire the advertisement information based further on the payment target information.

3. The display control system according to claim 2, wherein the at least one processor is configured to acquire, based on the payment target information, the advertisement information on the advertisement for one of the second article or the second service which tends to be purchased or used in combination with one of the first article or the first service.

4. The display control system according to claim 1, wherein the at least one processor is configured to:
determine whether an arrival time of each of a plurality of the second articles satisfies a predetermined arrival time condition; and
acquire the advertisement information on the advertisement for one of the plurality of the second articles that satisfies the predetermined arrival time condition.

5. The display control system according to claim 1, wherein the at least one processor is configured to:
determine whether a time limit of each of a plurality of the second articles satisfies a predetermined time limit condition; and
acquire the advertisement information on the advertisement for one of the plurality of the second articles that satisfies the predetermined time limit condition.

6. The display control system according to claim 1, wherein the at least one processor is configured to:
acquire balance information on a balance of payment means that has been used in the payment; and
acquire the advertisement information on the advertisement for one of the second article or the second service having a price equal to or lower than the balance indicated by the balance information.

7. The display control system according to claim 1, wherein the at least one processor is configured to:
acquire store use information on use of a store by one of the user or another user; and
acquire the advertisement information based further on the store use information.

8. The display control system according to claim 1, wherein the at least one processor is configured to:
acquire store classification information on a classification of the first store; and
acquire the advertisement information based further on the store classification information.

9. The display control system according to claim 1, wherein the at least one processor is configured to:
acquire first setting information on a setting of the advertisement specified by the first store; and
acquire the advertisement information based further on the first setting information.

10. The display control system according to claim 1, wherein the at least one processor is configured to:
acquire second setting information on a setting of the advertisement specified by the second store; and
acquire the advertisement information based further on the second setting information.

11. The display control system according to claim 1, wherein the at least one processor is configured to:
acquire reaction information on a reaction to each of a plurality of the advertisements; and
acquire the advertisement information based further on the reaction information.

12. The display control system according to claim 1, wherein the at least one processor is configured to:
acquire area information on an area of the first store; and
acquire the advertisement information based further on the area information.

13. The display control system according to claim 1, wherein the at least one processor is configured to:
acquire campaign information on a campaign held at the first store; and
acquire the advertisement information based further on the campaign information.

14. The display control system according to claim 1, wherein the at least one processor is configured to:
acquire another-service information on a use situation of one of the user or another user of another service different from a payment service relating to the payment; and
acquire the advertisement information based further on the another-service information.

15. A display control method in accordance with position information, the display control method comprising:
acquiring position information on a position of a first store at which payment based on a user terminal of a user has been executed;
acquiring advertisement information on an advertisement for one of a second article or a second service dealt in at a second store based on the position information; and
displaying on the user terminal a payment completion screen that relates to completion of the payment and includes the advertisement indicated by the advertisement information.

16. A non-transitory information storage medium having stored thereon a program for causing a computer to:
acquire position information on a position of a first store at which payment based on a user terminal of a user has been executed;
acquire advertisement information on an advertisement for one of a second article or a second service dealt in at a second store based on the position information; and
display on the user terminal a payment completion screen that relates to completion of the payment and includes the advertisement indicated by the advertisement information.
